(19) United States
(12) Patent Application Publication
(10) Pub. No.: US 2018/0014562 A1
(43) Pub. Date: Jan. 18, 2018

(54) ENZYMATIC TREATMENT OF PEANUTS

(71) Applicant: North Carolina Agricultural and Technical State University, Greensboro, NC (US)

(72) Inventor: Jianmei YU, Greensboro, NC (US)

(21) Appl. No.: 15/546,162

(22) PCT Filed: Jan. 28, 2016
(86) PCT No.: PCT/US16/15319

§ 371 Date: Jul. 25, 2017

Related U.S. Application Data
(60) Provisional application No. 62/109,039, filed on Jan. 28, 2015.

(51) Int. Cl. A23L 11/30; A23L 5/20

(52) U.S. Cl. CPC A23L 11/36; A23L 11/33; A23L 5/20; A23L 19/00

(57) ABSTRACT

The present application relates generally to the treatment of peanuts, red skin peanuts and/or peanut skins with an enzyme, in particular an endopeptidase enzyme such as a subtilisin, for example, alcalase, optionally in combination with an enzyme having exopeptidase activity, or in combination with ultrasonic treatment. The peanuts, red skin peanuts and/or peanut skins being treated can be raw, wet or dry blanched, roasted, or blanched and roasted.

### RELATED APPLICATION DATA

This application claims priority under 35 U.S.C. §119(e) to U.S. Provisional Patent Application No. 62/109,039 filed Jan. 28, 2015, the disclosure of which is incorporated herein by reference in its entirety.

### STATEMENT AS TO RIGHTS TO INVENTIONS MADE UNDER FEDERALLY SPONSORED RESEARCH OR DEVELOPMENT

This invention was made with Government support under award number: 2011-67017-30003 awarded by the USDA National Institute of Food Research, Agricultural and Food Research Initiative program. The Government has certain rights in this invention.

### FIELD

The present inventions relate generally to the treatment of peanuts, red skin peanuts, and/or peanut skins with one or more enzymes, and, optionally, using additional process steps such as heating and/or ultrasound, to reduce the concentration of allergenic proteins in the peanuts, red skin peanuts, and/or peanut skins.

### BACKGROUND

Peanut allergy is a severe and lifelong type of food allergy triggered by allergenic proteins and peptides in peanuts.

Peanut allergy is one of the most severe food allergies. Accidental ingestion of a small amount of any peanut product can produce lethal allergic reactions among hypersensitive individuals. The incidence of peanut allergies has been on the rise in recent years; for example, in Canada, the percentage of children allergic to peanuts increased from 1.3% in 2000-2002 to 1.6% in 2005-2007. This growth in allergic responses underscores the need to develop new methods to inactivate allergens that result in allergic reactions to food products, particularly peanuts. As of 2012, 13 proteins responsible for peanut allergy from peanut were recognized by the Allergen Nomenclature Sub-committee of the International Union of Immunological Societies. Among those proteins, more than 95% of peanut allergic individuals in the U.S. have specific IgE antibodies targeting Ara h 1 and Ara h 2 (See e.g. Scurlock, A. M., & Burks, A. W. (2004). “Peanut allergenicity” Annals of Allergy, Asthma, and Immunology, 93, SI 2-8). Reducing the levels of these allergens in peanuts and peanut derivatives before they are combined with other food ingredients can help protect consumers from potential life threatening allergic reactions related to accidental peanut exposure as well as enable consumption of peanut-containing products.

The molecular weights of the dominant peanut allergens are Ara h 1 about 63.7 kD; Ara h 2 about 16-17 kD; and Ara h 6 about 15 kD. Because Ara h 6 shares 59% sequence identity with Ara h 2, Ara h 2 and Ara h 6 have similar immunoreactivity in chimeric IgE ELISA and are considered the most potent peanut allergens accounting for the majority of effector activity in peanut extracts (Koid, A., et al. “Purified Natural Ara h 6: An Important Marker for IgE Responses to Peanut.” Journal of Immunology 188, 177.15. 2010; Chen, X., et al, “Analysis of the effector activity of Ara h 2 and Ara h 6 by selective depletion from a crude peanut extract.” J Immunol Methods 2011; 372(1-2):65-70; and Chen, X., et al, “Ara h 2 and Ara h 6 Have Similar Allergenic Activity and Are Substantially Redundant.” Int Arch Allergy Immunol 2012; 160(3):251-8.)

It is understood that to maintain the familiar taste and texture of peanuts and peanut products, it is important not to remove or digest all proteins in the food product, but instead to focus on the effectiveness of reducing the allergenicity of those peanut proteins to which consumers are most susceptible.

There remains a need for treatment of peanuts, red skin peanuts, and/or peanut skins that significantly reduces or eliminates the allergenic protein content contained therein. In particular, there is a need to identify a process that yields a peanut, red skin peanut, or peanut skin that either does not elicit an allergic reaction from people having identified peanut allergies or elicits a non-life-threatening reaction from such people.

### SUMMARY

Compositions and methods for enzymatically treating peanuts, red skin peanuts and/or peanut skins to reduce the concentration of allergenic proteins are disclosed. Depending on the embodiments, the peanuts, red skin peanuts, and/or peanut skins can be raw, wet or dry blanched, roasted, or roasted and wet or dry blanched.

The enzymatic treatment of peanuts, red skin peanuts, and/or peanut skins, alone or in combination with additional process steps, reduces the concentrations of major allergenic proteins (Ara h 1, Ara h 2 and Ara h 6).

In certain embodiments, the treatment involves treating peanuts, red skin peanuts, or peanut skins with one or more endopeptidases, which ideally include a subtilisin type protease. The enzymatic treatment reduces the concentrations of major allergenic proteins (Ara h 1, Ara h 2 and Ara h 6). Alcalase® (Novozymes) is a specific subtilisin type, though there are many subtilisin proteases generally known as “alcalase.” Accordingly, as used herein, the term “alcalase” is not limited to the specific enzyme sold by Novozymes under the name Alcalase®, except in the working examples, where the enzyme used was Alcalase®. According to some of the methods disclosed herein, alcalase treatment of peanuts increased protein solubility in buffered solution while decreasing Ara h 1, Ara h 2, and/or Ara h 6 concentrations relative to untreated peanuts (those not treated with enzyme). According to some of the methods disclosed herein, alcalase treatment of peanuts decreased measureable amounts of Ara hi, Ara h2, and/or Ara h6 in both the solubilized fraction (e.g. the extract) and the insoluble fraction (e.g. the residue). In other embodiments, the treatment involves treating peanuts, red skin peanuts, or peanut skins with one or more exopeptidases, which ideally include one or more members of the papain family, or flavourzyme.

In one embodiment, the endopeptidase is used in combination with an enzyme having exopeptidase activity. In one aspect of this embodiment, the endopeptidase is a subtilisin-type protease, such as alcalase. In another aspect, the endopeptidase is Neutrase. In yet another aspect of this embodiment, the exopeptidase is a member of the papain family. In yet another aspect, the exopeptidase is Flavourzyme. In a very specific embodiment, peanuts, red skin peanuts, and/or peanut skins are treated with alcalase and papain. In one variation, the enzymatic treatment steps are sequential; in another variation, the enzymatic treatment steps are coincident. In one variation, treatment with alcalase occurs before treatment with papain, in another variation, treatment with papain occurs before treatment with alcalase.

In another embodiment, the treatment involves using a combination of ultrasound and an endopeptidase and/or an exopeptidase. In one aspect of this embodiment, the endopeptidase is a subtilisin-type protease, such as alcalase or the endopeptidase is neutrase and/or the exopeptidase is a member of the papain family, or is flavourzyme. In aspects of this embodiment, a combination of an endopeptidase and an exopeptidase can be used as disclosed herein.

In a specific embodiment, raw peanuts, red skin peanuts, and/or peanut skins are enzymatically treated to reduce the concentrations of major allergenic proteins (Ara h 1, Ara h 2 and Ara h 6). In one aspect of this embodiment, the enzyme is an endopeptidase, such as neutrase. According to some of the methods disclosed herein, treatment of raw peanuts with neutrase increased protein solubility while decreasing Ara h 1, Ara h 2 and Ara h 6 concentrations relative to raw peanuts that were not treated with enzyme. According to some of the methods disclosed herein, treatment of peanuts with neutrase decreased measureable amounts of Ara hi, Ara h2 and/or Ara h6 in both the solubilized fraction and the insoluble fraction.

In another specific embodiment, raw peanuts, red skin peanuts, and/or peanut skins are enzymatically treated to reduce the concentrations of major allergenic proteins (Ara h 1, Ara h 2 and Ara h 6). In one aspect of this embodiment, the enzyme is an exopeptidase, such as a member of the papain family, and, more specifically, the enzyme is papain. According to some of the methods disclosed herein, treatment of raw peanuts with papain increased protein solubility while decreasing Ara h 1, Ara h 2 and Ara h 6 concentrations relative to raw peanuts that were not treated with enzyme. According to some of the methods disclosed herein, treatment of peanuts with papain decreased measureable amounts of Ara hi, Ara h2 and/or Ara h6 in both the solubilized fraction and the insoluble fraction.

In another specific embodiment, raw peanuts, red skin peanuts, and/or peanut skins are enzymatically treated to reduce the concentrations of major allergenic proteins (Ara h 1, Ara h 2 and Ara h 6). In one aspect of this embodiment, the enzyme is an endopeptidase, such as a subtilisin type protease, and, more specifically, the enzyme is alcalase or the endopeptidase is neutrase. Alternately the enzyme is an exopeptidase, such as a member of the papain family, or flavourzyme. According to some of the methods disclosed herein, treatment of raw peanuts with the disclosed enzyme increased protein solubility while decreasing Ara h 1, Ara h 2 and Ara h 6 concentrations relative to raw peanuts that were not treated with enzyme. According to some of the methods disclosed herein, treatment of peanuts decreased measureable amounts of Ara hi, Ara h2 and/or Ara h6 in both the solubilized fraction and the insoluble fraction.

In one aspect, the enzymatic treatment of raw peanuts, red skin peanuts, and/or peanut skins involves treatment with an endopeptidase and an exopeptidase. The exopeptidase can be, for example, a member of the papain family, and, more specifically, can be papain. In one variation, the enzymatic treatment steps are sequential, and in another variation, the enzymatic treatment steps are coincident. In one aspect of this embodiment, the peanuts and/or peanut skins are also subjected to ultrasound.

In another specific embodiment, raw peanuts, red skin peanuts, and/or red skins are wet or dry blanched, and treated with a subtilisin type protease, such as alcalase or the endopeptidase is neutrase, and/or an exopeptidase, such as a member of the papain family, or flavourzyme. In one aspect of this embodiment, the peanuts, red skin peanuts, and/or peanut skins are also subjected to ultrasound.

In yet another specific embodiment, peanuts, red skin peanuts, and/or peanut skins are roasted, and are optionally also blanched, before or after roasting, before being treated with a subtilisin type protease, such as alcalase or the endopeptidase is neutrase and/or an exopeptidase, such as a member of the papain family, or flavourzyme. In one aspect of this embodiment, the peanuts, red skin peanuts and/or peanut skins are also subjected to ultrasound.

These and other objects and aspects of the present inventions will become apparent to those skilled in the art after a reading of the following description of the disclosure when considered with the drawings.

### BRIEF DESCRIPTION OF THE DRAWINGS

FIG. 1 shows SDS-PAGE of raw peanut kernels: Gel E: Extracts of samples treated with alcalase for 2.0 hours; Gel F: pellets of samples treated with alcalase for 2.0 hours. Lane 1-molecular marker; Lane 2-control; Lane 3-no enzyme; Lane 4-1.52 U/100 g peanuts; Lane 5: 3.03 U/100 g peanuts; Lane 6: 4.54 U/100 g peanuts, Lane 7: 6.05 U/100 g peanuts; Lane 8: 7.56 U/100 g peanuts; Lane 9: 9.08 U/100 g peanuts

FIG. 2 shows SDS-PAGE of raw peanut kernels: Gel G: Extracts of samples treated with alcalase for 3.0 Hours; Gel H-pellets of samples treated with alcalase for 3.0 hours. Lane 1-molecular marker; Lane 2 and Lane 3: control; Lane 4-no enzyme; Lane 5-1.52 U/100 g peanuts; Lane 6: 3.03U/100 g peanuts; Lane 7: 4.54 U/100 g peanuts, Lane 8: 6.05 U/100 g peanuts; Lane 9: 7.56 U/100 g peanuts; Lane 10: 9.08 U/100 g peanuts.

It will be understood that the drawings are for the purpose of describing a preferred embodiment of the inventions and are not intended to limit the inventions thereto.

### DETAILED DESCRIPTION

This description is not intended to be a detailed catalogue of all the ways in which the present invention may be implemented or of all the features that may be added to the present invention. For example, features illustrated with respect to one embodiment may be incorporated into other embodiments, and features illustrated with respect to a particular embodiment may be deleted from that embodiment. Thus, one or more of the method steps included in a particular method described herein may, in other embodiments, be omitted and/or performed independently. In addition, numerous variations and additions to the embodiments suggested herein, which do not depart from the instant invention, will be apparent to those skilled in the art in light of the instant disclosure. Hence, the following description is intended to illustrate some particular embodiments of the invention, and not to exhaustively specify all permutations, combinations and variations thereof. It should therefore be appreciated that the present invention is not limited to the particular embodiments set forth herein. Rather, these particular embodiments are provided so that this disclosure will more clearly convey the full scope of the invention to those skilled in the art.

The terminology used herein is for the purpose of describing particular embodiments of the present invention only and is not intended to limit the present invention. Although the following terms are believed to be well understood by one of skill in the art, the following definitions are set forth to facilitate understanding of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art.

### Definitions

As used herein, the terms “a” or “an” or “the” may refer to one or more than one. For example, “a” peanut can mean one peanut or a plurality of peanuts.

As used herein, the term “about,” when used in reference to a measurable value such as an amount of mass, enzyme, time, temperature, and the like, is meant to encompass variations of +/−20% of the specified amount. All ranges set forth, unless otherwise stated, include the stated endpoints and all increments between.

As used herein, the term “and/or” refers to and encompasses any and all possible combinations of one or more of the associated listed items, as well as the lack of combinations when interpreted in the alternative (“or”).

As used herein, “peanuts” refers to whole peanuts, peanut kernels or fragments thereof, but does not include peanut oil, peanut flour, peanut protein hydrolysate, peanut protein isolate or peanut protein extracts.

As used herein “raw peanut” refers to a peanut kernel that has been removed from its shell, is optionally cleaned, and has had the peanut skin removed. Many commercial sources of peanuts sell raw peanuts (e.g. Good Earth Peanut Company (Skipper, Va.)). Beyond the steps necessary to remove peanut skins, raw peanuts described herein are not additionally heat treated, unless explicitly identified as such.

As used herein, “red skin peanuts” refers to peanuts that still have their skin attached. Generally red skin peanuts have been removed from the shell and are optionally cleaned. Typically, red skin peanuts have not been exposed to either dry heat or wet heat (such as wet or dry blanching conditions), which generally facilitates removal of the peanut skin, while the removal of the shell is a physical processing step.

As used herein, “red skin” refers to the peanut skin. In some embodiments, the peanuts treated using the methods described herein include their skin during the enzymatic treatment, and in other embodiments, the skin is removed and enzymatically treated to remove allergens. The red skin can be raw, blanched, roasted, or blanched and roasted.

Methods designed to remove peanut skins are known in the art and include, but are not limited to, dry methods (such as freezing for at least a few hours or roasting for a few minutes) and wet methods (such as wet blanching for a few minutes). Usually, dry blanching is a three step operation, starting with the slitting of the nut skins by passing nuts between a pair of resiliently mounted blades. The nuts are then heated to cause the skin to peel slightly back from the slit portion and, finally, the nuts are transferred onto a moving belt which carries the nuts against fixed abrasive baffles extending above and diagonally across the surface of the moving belt. The abrasive baffles in combination with the moving belt fully remove the dark skin from the nuts. This process is exemplified, for example, in U.S. Pat. Nos. 2,605,797, 2,699,806 and 3,196,914.

Wet blanching conditions typically involve heating the red skin peanuts, for example, for between 1 and 3 minutes, with water at a temperature typically close to boiling, and more typically in the range of 70-100° C.

I. Types of Peanuts that can be Treated

In some embodiments of the methods disclosed herein, the peanuts are raw, and in other embodiments, the peanuts are wet or dry blanched and/or roasted.

In some embodiments, it can be desired to maintain the red skin on the peanuts, and in others, it can be desired to remove the red skin. So, it is contemplated that both raw peanuts and red skin peanuts can be treated according to the methods disclosed herein. Where the red skin is removed, it can be separately treated to remove allergens using the same conditions used to treat the rest of the peanut.

Peanut skins, which make up about 3 percent of a peanut kernel, are rich in antioxidant phenolic compounds and can be used, for example, as a nutritional supplement. A concentration of around 5 percent of peanut skins can be present in peanut butter without sacrificing taste or texture, while significantly increasing its antioxidant levels. As with the peanuts, the peanut skins can be raw, blanched, or roasted. The roasted peanut skins have higher levels of antioxidant-rich phenolic compounds than their raw or blanched counterparts. Roasted peanut skins also have a higher antioxidant content than either vitamin C or green tea, and, because the allergens are largely removed, can be included in nutritional supplements, particularly those where antioxidant properties are desirable.

### II. Enzymes

The methods described herein typically involve treating the peanuts and/or peanut skins with an endopeptidase. In one embodiment, the endopeptidase is a subtilisin type protease, that is, an enzyme that is structurally related to or derived from subtilisin, as produced by different Bacillus bacterial strains. Examples of such proteases can be found, for example, in Markland, F. S., & Smith, E. L. (1971). Subtilisins: primary structure, chemical and physical properties, in: The enzyme (3rd edition, edited by P. D. Boyer), Vol. 3, pp: 561-608. Academic Press, New York, USA. For example, Subtilisin A is an alkaline non-specific serine protease from Bacillus subtilis that initiates a nucleophilic attack on a peptide bond through a serine residue at the active site; it catalyzes the hydrolysis of proteins and peptide amides. Subtilisin type proteases generally have molecular weights between about 20,000 and about 30,000 and have a serine residue in the active site of the enzyme. Subtilisin has broad specificity with a preference for a large uncharged residue in the PI position. It hydrolyzes native and denatured proteins and is active under alkaline conditions.

Subtilisin type proteases include, but are not limited to Alcalase® and generic forms thereof, Esperase® (“a highly alkalophilic bacterial proteinase produced by Bacillus lentus. The enzyme hydrolyzes peptide bonds comprising the carboxylic groups of hydrophobic as well as hydrophilic residues in the oxidized insulin B chain.” Dessislava Nikolova Georgieva et al, Current Microbiology, May 2001, Volume 42, Issue 5, pp 368-371 “Substrate Specificity of the Highly Alkalophilic Bacterial Proteinase Esperase: Relation to the X-Ray Structure”), Savinase (a serine endopeptidase consisting primarily of subtilisin A; it catalyzes stereoselective hydrolysis of some esters and strained amides under alkaline conditions), Subtilisin NOVO (see e.g. Olaitan et al. The Journal of Biological Chemistry 243: 5296-5301 “The Structure of Subtilison Novo), Everlase®, Ovozyme®, Coronase®, Polarzyme®, Kannase®, Liquanase®, and Relase®, (Novozymes Corp., Copenhagen, Denmark), Maxataset™, Maxacal™, Maxapem™, Properase™, Purafect™, Purafect Oxp™, Fn2™, Fn3™, Fn4™ (Genencor, Palo Alto, Calif.) or protein engineered variants of these. Production of these and variations of such enzymes are known in the art (see for example U.S. Pat. No. 3,623,957, U.S. Pat. No. 8,557,553, U.S. 2012/0252106 and references thereto).

One specific form of subtilisin protease is alcalase. Alcalase is a serine protease commercially produced from Bacillus licheniformis. Alcalase is a protease preparation of subtilisin, which is a non-glycosylated single polypeptide chain without disulfide bonds and a MW of 15-30 KDa (Gupta, R., Beg, Q. K., & Lorenz, P. (2002). Bacterial alkaline proteases: molecular approaches and industrial applications. Applied Microbiology and Biotechnology, 59, 15-32.). As described herein, the term “alcalase” is not limited to the specific enzyme sold by Novozymes under the name Alcalase®, except in the working examples, where the enzyme used was Alcalase®.

Another form of endopeptidase is Neutrase® (Novozyme Corp., Copenhagen, Denmark), a bacterial protease produced by a selected strain of Bacillus amyloliquefaciens.

In some embodiments, an endopeptidase is used in combination with other enzymes. In some aspects of these embodiments, the enzymes are compatible with each other, in that they can be used at the same temperature and pH. In other aspects of these embodiments, the enzymes are not compatible with each other, in that their maximum enzymatic activity is observed at a temperature range or a pH range at which the activity of the other enzyme drops below a desired level, for example, 10 percent, 20 percent, 30 percent, or 40 or more percent below its maximum activity. Where enzymes are compatible, they can be added to the peanuts, red skin peanuts and/or peanut skins in the form of an enzymatic preparation, or individually added, and both enzymatic steps can occur simultaneously. Where enzymes are incompatible, the enzymatic steps can be run sequentially. Those of skill in the art can readily determine the optimum temperature and pH ranges for the enzymes described herein, and can thus determine whether enzyme combinations are compatible or incompatible.

One suitable combination is the combination of an endopeptidase and an exopeptidase. This combination is particularly useful for treating raw peanuts and/or peanut skins, and blanched peanuts and/or peanut skins, as the combination may remove a significantly higher amount of the peanut allergens (Ara h 1, Ara h 2, and Ara h 6) than endopeptidase alone.

Members of the papain family are examples of suitable exopeptidases. As used herein, the term “papain family” refers to a family of related proteins with a wide variety of activities, including endopeptidases, aminopeptidases, dipeptidyl peptidases and enzymes with both exo- and endo-peptidase activity (Rawlings N D, Barrett A J (1994). “Families of cysteine peptidases”. Meth. Enzymol. 244: 461-486). Members of the papain family are widespread, found in baculovirus, eubacteria, yeast, and practically all protozoa, plants and mammals. The proteins are typically lysosomal or secreted, and proteolytic cleavage of the propeptide is required for enzyme activation, although bleomycin hydrolase is cytosolic in fungi and mammals. Papain-like cysteine proteinases are essentially synthesized as inactive proenzymes (zymogens) with N-terminal propeptide regions. The activation process of these enzymes includes the removal of propeptide regions, which serve a variety of functions in vivo and in vitro. The pro-region is required for the proper folding of the newly synthesized enzyme, the inactivation of the peptidase domain and stabilization of the enzyme against denaturing at neutral to alkaline pH conditions. Amino acid residues within the pro-region mediate their membrane association, and play a role in the transport of the proenzyme to lysosomes. Among the most notable features of propeptides is their ability to inhibit the activity of their cognate enzymes and that certain propeptides exhibit high selectivity for inhibition of the peptidases from which they originate.

Another exopeptidase included in the methods disclosed herein is Flavourzyme® (Novozyme Corp., Copenhagen, Denmark), a fungal protease/peptidase complex produced by fermentation of Aspergillus oryzae.

Enzyme Preparations

In connection with the enzyme preparations described herein, the enzyme, such as for example, alcalase, neutrase, papain or flavourzyme can comprise at least about 50% of the total enzyme composition. In one embodiment, the enzyme may comprise at least about 60%, at least about 70%, at least about 80%, at least about 90%, or at least about 95%, of the total enzyme composition. In another embodiment, the enzyme can comprise at least about 99% of the total enzyme composition. Generally, the enzyme is commercially available as a liquid comprising between about 5% and about 25% dry mass enzyme in solution. Other commercial sources are also available and familiar to those of skill in the art. In one aspect of this embodiment, the enzyme is a subtilisin-type protease, such as alcalase.

Use Rates for the Enzymes

In one embodiment, the use rate (or ratio) of enzyme to mass of peanut ranges from about 0.1 U/100 gram peanuts to about 20 U/100 gram peanuts, more specifically, from about 1 U/100 gram peanuts to about 10 U/100 gram peanuts, even more specifically, from about 3 U/100 gram peanuts to about 6 U/100 gram peanuts, and still more specifically, from about 4 U/100 gram peanuts to about 5 U/100 gram peanuts.

In one embodiment, the ratio is no more than about 0.5 U/100 g peanuts, no more than about 1 U/100 g peanuts, no more than about 1.5 U/100 g peanuts, no more than about 2 U/100 g peanuts, no more than about 2.5 U/100 g peanuts, no more than about 3 U/100 g peanuts, no more than about 3.5 U/100 g peanuts, no more than about 4 U/100 g peanuts, no more than about 4.5 U/100 g peanuts, no more than about 5 U/100 g peanuts, no more than about 5.5 U/100 g peanuts, no more than about 6 U/100 g peanuts, no more than about 6.5 U/100 g peanuts, no more than about 7 U/100 g peanuts, no more than about 7.5 U/100 g peanuts, no more than about 8 U/100 g peanuts, no more than about 8.5 U/100 g peanuts, no more than about 9 U/100 g peanuts, no more than about 9.5 U/100 g peanuts, or no more than about 10 U/100 g peanuts.

Alternately, the ratio of enzyme to peanut (as measured either in volume enzyme solution to mass of peanut substrate or mass of enzyme to mass of peanut substrate) is characterized as a percentage. Such a ratio can be between about 0.05% and about 5.0% or between about 0.2% to about 2.5% or between about 0.5% and about 1.0%.

In one aspect of these embodiments, the enzyme is a subtilisin-type protease, such as alcalase. In another aspect of these embodiments, the enzyme is neutrase. In yet another aspect of these embodiments, the enzyme is papain.

Reaction Conditions for Subtilisin-Type Protease

In one embodiment, enzymatic treatment occurs with a subtilisin-type protease, such as for example, alcalase, in a buffered solution between about 30° C. and about 75° C.; in another embodiment between about 35° C. and about 70° C.; in yet another embodiment between about 40° C. and about 65° C.; in still another embodiment, between about 45° C. and about 55° C. In one variation, the enzymatic treatment occurs at no more than 40° C., at no more than 50° C., at no more than 60° C. or at no more than 70° C. In one variation, the peanuts are treated with a subtilisin type protease for no more than about 15 minutes, for no more than about 30 minutes, for no more than about 1 hour, for no more than about 1.5 hours, for no more than about 2 hours, for no more than about 2.5 hours or for no more than about 3 hours. In another variation, the enzymatic treatment occurs for at least about 15 minutes, for at least about 30 minutes, for at least about 1 hour, for at least about 1.5 hours, for at least about 2 hours, for at least about 2.5 hours or for at least about 3 hours.

In one embodiment, the present application discloses a method for treating a raw peanut kemel with alcalase. In one variation of such an embodiment, measured amounts of Ara hi and Ara h2 are reduced by more than 99% and measured amounts of Ara h6 are reduced by at least about 65%, at least about 95% or even at least about 97%. In one variation, the enzymatic solution is buffered to a pH of between about 7 and about 8 at a temperature of between about 45° C. and about 55° C. and the peanut kernel is treated for between about 0.5 and 3.0 hours.

Reaction Conditions for Enzymes

In one variation, treatment of peanuts with papain can take place in solution buffered at a pH of between about 6 and about 7 at a temperature between about 55° C. and about 75° C., typically about 65° C. In another variation, treatment of peanuts with Neutrase® can take place in solution buffered at a pH of between about 5.5 and 7.5, typically about 7, at a temperature between about 45° C. and about 55° C. In yet another variation, treatment of peanuts with Flavourzyme® can take place in solution buffered at a pH of between about 5 and about 7, at a temperature between about 40° C. and about 60° C., typically between about 50° C. and about 55° C.

Considerations for Sequential Enzymatic Treatment

Typically, when peanuts, red skin peanuts and/or peanut skins are to be treated with sequential enzymatic steps, after the first enzymatic treatment, the samples are heated sufficient to inactivate the first enzyme. The buffered solution is then adjusted to the optimal pH of the second enzyme and then the peanuts are incubated at a temperature optimized for the second enzymatic treatment step. In one variation, the first enzymatic treatment is with an enzyme having endopeptidase activity, such as a subtilisin-type enzyme, and the second treatment is with an enzyme having exopeptidase activity, such a papain. In another variation, the first enzymatic treatment is with an enzyme having exopeptidase activity and the second enzymatic treatment is with an enzyme having endopeptidase activity.

As disclosed herein, the endopeptidase treated peanuts are treated with varying ratios of an enzyme having exopeptidase activity to mass of peanut (e.g. between about 1 and about 9 U/100g dry peanuts, or between about 0.03 and about 0.3% w/w, dry weight). In one variation, the peanuts are treated with the enzyme having exopeptidase activity for no more than about 15 minutes, for no more than about 30 minutes, for no more than about 1 hour, for no more than about 1.5 hours, for no more than about 2 hours, for no more than about 2.5 hours or for no more than about 3 hours. In another variation, the enzymatic treatment occurs for at least about 15 minutes, for at least about 30 minutes, for at least about 1 hour, for at least about 1.5 hours, for at least about 2 hours, for at least about 2.5 hours or for at least about 3 hours.

### III. Ultrasonic Treatment

In some embodiments, the enzymatic treatment is assisted by using ultrasound. Ultrasound (sonication) is usually operated at the frequency range of 20-100 kHz in the presence of a liquid medium (see, for example, Wambura et al, Food and Bioprocess Technology, vol. 4, no. 1, pp. 107-115, 2011).

For example, peanuts, red skin peanuts and/or peanut skins can be added to an aqueous solution, which can be a buffered solution, such as a phosphate buffer (typically at a pH of around 7.5), and sonicated in a water bath sonicator (such as those sold by the Branson Cleaning Equipment Company, Danbury, Conn.). Typically, the sonication time is less than about 1 hour, less than a half an hour, less than 15 minutes, or less than 10 minutes, or less than 5 minutes, at a range of from 10 to 100 Hz, more specifically, at around 40-60 Hz, still more specifically, at around 50 Hz. As is readily understood to one of skill in the art, different sonicators and different frequency ranges will lead to different treatment times.

Peanuts can optionally be roasted and/or blanched, before or after ultrasonic treatment, and then bombarded with ultrasound for as little as a few minutes. This treatment typically removes oil from the outer surface of the peanuts and a thin layer just below it.

If desired, after the enzymatic treatment, the peanuts can be provided with a coating, such as a plant-derived edible coating, that contains antioxidants, to block out oxygen. Representative coatings include corn protein, whey protein, and celluloses, such as carboxymethyl cellulose, or CMC, optionally including antioxidants, including natural antioxidants such as tea extracts, to delay the time in which the peanuts go rancid. Further, perhaps because the oil is removed from the outer surface, coatings such as honey (as is used to produce honey-roasted peanuts) tend to adhere better to sonicated peanuts (Wambura et al, Food and Bioprocess Technology, July 2012, Volume 5, Issue 5, pp 2012-2016).

Depending on the application, the sonication can be performed in aqueous media, or in organic solvents, such as hexane and/or petroleum ether, though aqueous media can be preferred. For example, peanuts and/or peanut skins can be added to an aqueous solution, which can be a buffered solution, such as a phosphate buffer (typically at a pH of around 7.5), and sonicated in a water bath sonicator (such as those sold by the Branson Cleaning Equipment Company, Danbury, Conn.), typically for no less than about five minutes, and for no more than about 1 hour, at between around 20 and 100 Hz, for example, around 50 Hz.

The combination of ultrasonication pretreatment and endopeptidase treatment, such as alcalase treatment, generally affects the solubility of peanut proteins, including the allergenic proteins. Ultrasound treatment for up to about one hour generally increases the amount of protein extractable from peanuts. Generally, at constant treatment time, total soluble protein increases as the ratio of endopeptidase, such as alcalase, to grams of peanut increases. When the ratio of enzyme to peanut is kept fixed, total soluble protein generally increases with treatment time. Typically, treatment time has a greater effect on the concentration of soluble protein than increasing the enzyme concentration. Without being bound by a particular theory, it is believed that ultrasound treatment 100 sens the peanut kernel structure and facilitates the diffusion of enzymes into peanut kernel. The concentration of protein solubilized in the soaking solution increases with enzyme concentration and soaking time. It is possible that longer soaking would reduce the concentrations of allergenic proteins even further.

The conditions described above generally remove the excess moisture from the peanuts/peanut skin, and inactivate the enzyme(s).

### IV. Heat Treatment of Peanuts

When peanuts, red skin peanuts, and/or peanut skins are blanched, the blanching time is typically between 1 to 3 minutes, with water at a temperature typically close to boiling, and more typically in the range of 70° C. to 100° C. After blanching, the peanuts, red skin peanuts, and/or peanut skins are cooled to between around 37° C. and 42° C., more typically around 38° C., to avoid overheating the enzyme to be used in the enzymatic treatment step.

In one embodiment, raw peanuts or raw red skin peanuts are blanched in heated water, such as boiling water, for between about 30 seconds and about 10 minutes. In one embodiment, the raw peanuts or raw red skin peanuts are blanched for between about 1 minute and about 6 minutes; or for between about 1 minute and about 5 minutes; or for between about 2 minutes and about 4 minutes. Typically, they are blanched for no longer than about 5 minutes, or no longer than about 4 minutes, or no longer than about 3 minutes, no longer than about 2 minutes or no longer than about 1 minute. After blanching, the peanuts are typically drained. The blanched peanuts or blanched red skin peanuts can then be cooled before enzymatic treatment. Typically, they are cooled at least to the upper temperature range for enzymatic treatment, for example, cooled to at least about 80° C. or at least about 70° C. or at least about 60° C. or at least about 50° C. or at least about 40° C. Alternately, they can be cooled to room temperature, typically 25° C. Alternately, they are cooled to between about 30° C. and about 75° C.; in another embodiment between about 35° C. and about 70° C.; in yet another embodiment between about 40° C. and about 65° C.; in still another embodiment, between about 45° C. and about 55° C. More typically, the blanched peanuts or blanched red skin peanuts are cooled to about 50° C.

When peanuts, red skin peanuts, and/or peanut skins are roasted, typical conditions for roasting raw shelled peanuts involve heating the peanuts to a temperature of between around 160° C. and 200° C., for a roasting time typically between about 20 and 30 minutes. For roasting raw, unshelled peanuts, the roasting time is typically increased to between around 30 and 35 minutes. To prevent the peanut from scorch and self-ignition, the peanut temperature is ideally lowered soon after roasting. Times will vary depending on the roaster and degree of doneness desired, and those of skill in the art will know what conditions are appropriate.

Peanuts can also be roasted in a microwave. Times will vary depending on the microwave and degree of doneness desired, and those of skill in the art will know what conditions are appropriate.

V. Drying the Treated Peanuts and/or Peanut Skins

In order to convert peanuts and/or peanut skins into hypoallergenic peanuts and/or peanut skins, they may be soaked in an enzymatic solution at conditions sufficient for the enzymes to substantially penetrate the entire volume of the peanuts and/or skins and break down the allergenic proteins and peptides within the interior volume of the peanuts/peanut skins. This can require relatively long soaking times, relatively high temperatures, and relatively high enzymatic concentrations.

It should be noted that modest amounts of mycotoxins, such as aflatoxin, can develop any time organic matter, such as peanuts or peanut skins, is soaked and then dried over time. This is a surmountable issue well understood in the industry. The risk can be mitigated by a variety known of techniques, for example, increasing the temperature, air flow, vacuum pressure, or relative dryness of the air which can be used to dry the peanuts and/or peanut skins.

Accordingly, the enzyme-treated peanuts/peanut skins are typically dried after being treated using the methods described herein. The temperatures, reaction times, and enzyme concentrations used to treat the peanuts will depend on the desired reduction in allergen concentration. The temperatures and times used to dry the peanuts will similarly depend on the desired moisture content of the treated peanuts. Typical drying conditions include heating the peanuts at a temperature of between about 50° C. and about 100° C., more typically between about 60° C. and about 80° C., and, more specifically, around 70° C. and around 72° C. Drying can be carried out in a commercial dehydrator, a vacuum drying oven, on vacuum drying racks or other vacuum drying systems, or using conventional heaters, for a suitable period of time, typically between about 4 and about 24 hours, until a suitable dryness is achieved. Vacuum drying systems typically include a mixer/blender, filter condenser, vacuum pump, and a condensate receiving vessel. Conveyor dryers, drum dryers, fluid bed dryers, pan dryers, rotary dryers, shelf dryers, calciner dryers, spray dryers, vacuum dryers, and twin shell dryers can all be used.

Microwave drying can also be performed (Pominski and Vinnett, “Production of Peanut Flour from Microwave Vacuum-Dried Peanuts, Journal of Food Science, Volume 54, Issue 1, pages 187-189, January 1989). On the laboratory scale, drying can take place, for example, in an Isotemp 281 A vacuum oven (Fisher Scientific, Pittsburgh, Pa.).

The enzymatically treated peanuts can be dried until suitable dryness is achieved. The moisture content of the dried peanuts usually is typically reduced to 5% or less, preferably about 1.5-3.5%. Generally, the enzymatically treated peanuts are dried to a water content of less than about 6%, to less than about 5%, less than about 4%, less than about 3% or less than about 2%. Usually, the treated peanuts are dried until the water content is less than about 3%. Alternately, the moisture content of the dried peanuts usually is reduced to 5% or less, such as between about 1.5 and 3.5% or dried until the moisture content is less than about 3%.

The resulting enzymatically treated and dried peanuts can be cooled to room temperature, and then the peanuts and/or peanut skins can be used for a variety of desired purposes, including conversion to roasted and/or salted peanuts, peanut butter, peanut oil, peanut flour, and the like.

VI. Methods of Treating Peanuts, Red Skin Peanuts, and/or Peanut Skins

In the embodiments described below, peanuts, red skin peanuts, and/or peanut skins are treated with an endopeptidase, such as a subtilisin type protease, for example, alcalase or the endopeptidase is neutrase, and/or an exopeptidase, such as papain or other members of the papain family, or flavourzyme.

The treatment is carried out at a sufficient concentration, at a sufficient temperature, and for a sufficient time, to remove a desired amount of the allergens. The methods are carried out such that those allergens which cause allergic reactions in the majority of those people who suffer from peanut allergies have been either substantially (i.e., greater than about 50%) reduced or completely (100%) eliminated, or some value in between. Some of the processes described herein are capable of removing at least around 90% of Ara h 1 and Ara h 2, and at least around 50% of Ara h 6, and in one embodiment, this level or higher of allergen removal is attained. Some of the processes described herein remove at least about 95% of each of Ara hi and Ara h2 and at least about 65% of Ara h6. Other processes described herein remove at least about 99% of each of Ara hi and Ara h2 and at least about 50% of Ara h6, or at least about 55% Ara h6 or at least about 60% Ara h6 or at least about 65% Ara h6 or at least about 70% Ara h6. In one aspect, the present application discloses methods reducing allergenic proteins by at least about 50%, or at least about 75%. In another aspect, the methods reduce allergenic proteins by at least about 90%, or at least about 95% or at least about 99%. In one embodiment of any of the disclosed aspects, any one of Ara h i, Ara h 2, or Ara h 6 is reduced. In another embodiment of any of the disclosed aspects, any combination of two of Ara h i, Ara h 2, or Ara h 6 is reduced. In yet another embodiment of any of the disclosed aspects, of each of Ara h 1, Ara h 2, and Ara h 6 is reduced.

Those of skill in the art, using the examples described herein, can readily determine the appropriate concentration, temperature, and treatment time to achieve the desired goals, namely, a reduction in the concentrations of major allergenic proteins (Ara h 1, Ara h 2 and Ara h 6).

In one embodiment, the enzyme is a subtilisin type protease, which is an enzyme that is structurally related to or derived from subtilisin, as produced by different Bacillus bacterial strains. In one aspect of this embodiment, the endopeptidase is Alcalase. In other embodiments, the subtilisin-type protease is selected from Esperase®, Savinase, Subtilisin NOVO, Everlase, Ovozyme, Coronase, Polarzyme, Kannase, Liquanase, and Relase, (Novozymes), Maxatase, Maxacal, Maxapem, Properase, Purafect, Purafect Oxp, Fn2, Fn3, and Fn4 (Genencor) or protein engineered variants of these. Production of these and variations of such enzymes, such as protein-engineered variants thereof, are known in the art (see for example U.S. Pat. No. 3,623,957, U.S. Pat. No. 8,557,553 and references thereto).

The enzyme used to remove peanut allergens can be part of an enzyme preparation, which may, but does not need to, include other enzymes. In such a preparation, the enzyme, such as a subtilisin-type protease, may comprise at least about 50%, at least about 60%, at least about 70%, at least about 80%, at least about 90%, at least about 95%, or at least about 99% of the total enzyme composition. Generally, the enzyme is commercially-available as a liquid comprising between about 5% and about 25% dry mass enzyme in solution. Other commercial sources are also available and familiar to those of skill in the art. The use rates for enzymes relative to peanuts are described elsewhere herein.

In various embodiments, the peanuts and/or peanut skins can be raw, (wet or dry) blanched raw, roasted, or (wet or dry) blanched and roasted peanuts. These peanuts and/or peanut skin are treated to significantly decrease Ara h 1, Ara h 2 and Ara h 6 concentrations relative to untreated peanuts (i.e., those not treated with enzyme). Roasting and/or blanching raw peanuts or peanut skins helps reduce the concentrations of major allergenic proteins (Ara h 1, Ara h 2 and Ara h 6).

In one embodiment, the peanuts are treated while they are still raw, either with or without the red skins being removed. This embodiment can be preferred, because when shipped to an end-user, they can have sufficiently low allergen content, and the end-user can decide whether to roast, blanch, or otherwise treat the allergen-reduced raw peanuts and/or skins.

In some embodiments, the peanuts are wet or dry blanched using the temperature and time ranges discussed above, during which time the thin dark skin of the shelled peanuts can be removed, if desired. After being blanched, the peanuts or peanut skins are typically drained (when they are wet blanched), and cooled to a temperature of between about 15 and about 50° C. If the peanuts and/or skins are also to be roasted, they can be subjected to a roasting process before being cooled, as they would only be re-heated in the roasting step. Alternatively, the roasting step can occur before the blanching step.

In those embodiments where peanuts and/or peanut skins are roasted, typical conditions for roasting raw shelled peanuts involve heating the peanuts to a temperature of between around 160° C. and 200° C., for a roasting time typically between about 20 and 30 minutes. For roasting raw, unshelled peanuts, the roasting time is typically increased to between around 30 and 35 minutes. To prevent the peanut from scorch and self-ignition, the peanut temperature is ideally lowered soon after roasting. Peanuts can also be roasted in a microwave. Times will vary depending on the microwave and degree of doneness desired, and those of skill in the art will know what conditions are appropriate.

After roasting and/or blanching, and before enzymatic treatment, the peanuts and/or peanut skins are typically cooled. The actual temperature to which the peanuts and/or peanut skins are cooled will vary, and can depend, for example, on the temperature at which the enzymatic treatment will take place. For example, alcalase treatment is preferably carried out at a temperature of around 42° C., where the alcalase activity is fairly high.

The cooled peanuts/skins can then be incubated in an enzyme solution, which can be buffered to a pH at which the enzyme has relatively high activity, at a temperature between about 40° C. and the temperature at which the enzyme is denatured, more typically, around 40-50° C., for a time between about 0.5 and about 3 hours, with varying ratios of enzyme to peanut, as discussed above.

While additional incubation times can be used, they tend to adversely affect the physical and/or mechanical properties of the peanuts, or the antioxidant content of the peanut skins. As extra incubation time has little beneficial effect on the peanuts or skins, it is preferred to not exceed the 3 hour time period, particularly as it can adversely affect the physical and mechanical properties of the peanut, for example, the rupture force, as discussed in detail below.

The treated peanuts can be dried under suitable conditions, for example, at a temperature of around 80° C. for a suitable period of time, typically between about 4 and about 24 hours, using any of the drying apparatuses described herein, until a suitable dryness is achieved.

The resulting enzymatically treated and dried peanuts can be cooled to at or below room temperature, and then either stored, or converted to desired products, such as peanut butter, peanut flour, peanut oil, roasted and/or salted peanuts, and the like.

In addition to or in place of the endopeptidase, the enzymatic treatment can comprise treatment with an exopeptidase. Enzymes having exopeptidase activity include enzymes in the papain family, for example, papain, which additionally has endopeptidase activity. The enzymatic treatment steps with endo and exopeptidases can be sequential or coincident. Sequential treatment can be preferred if the enzymes are incompatible, as this term is defined elsewhere herein.

The enzymatic treatment can be assisted by using ultrasound as disclosed herein. For example, peanuts or peanut skins can be added to an aqueous or organic media, which can be a buffered solution, such as a phosphate buffer (typically at a pH of around 7.5), and sonicated using the conditions described elsewhere herein.

If desired, the solutions in which the peanuts and/or peanut skins are soaked can be collected separately, and/or at different time intervals, for subsequent analysis.

Enzyme-treated peanuts/peanut skins can then be dried using the drying conditions described herein, typically to a moisture content of around 5% or less, preferably about 1.5-3.5%.

The temperatures, reaction times, and enzyme concentrations used to treat the peanuts will depend on the desired reduction in allergen concentration. The temperatures and times used to dry the peanuts will depend on the desired moisture content of the treated peanuts.

The combination of ultrasonication pretreatment and endopeptidase treatment, such as alcalase treatment, and/or exopeptidase treatment, such as papain or flavourzyme treatment, generally affects the solubility of peanut proteins, including the allergenic proteins. Ultrasound treatment for up to about one hour generally increases the amount of protein extractable from peanut kernels. Generally, at constant treatment time, total soluble protein increases as the ratio of enzyme to grams of peanut increases. When the ratio of enzyme to peanut is kept fixed, total soluble protein generally increases with treatment time. Typically, treatment time has a greater effect on the concentration of soluble protein than increasing the enzyme concentration. Without being bound by a particular theory, it is believed that ultrasound treatment 100 sens the peanut kernel structure and facilitates the diffusion of enzymes into peanut kernel. The concentration of protein solubilized in the soaking solution increases with enzyme concentration and soaking time. It is possible that longer soaking would reduce the concentrations of allergenic proteins even further.

Every possible permutation described above is intended to be an individual embodiment of the methods described herein.

In one embodiment, the methods are used to treat raw peanuts, red skin peanuts, and/or peanut skins. The raw peanuts, red skin peanuts, and/or peanut skins can be treated with a subtilisin-type protease, such as alcalase or any of the other endopeptidase enzymes described above, and/or an exopeptidase, such as a member of the papain family. The treatment method can optionally include a wet or dry blanching step, and, optionally, a step wherein the raw peanuts have their red skin removed. In one aspect of this embodiment, the enzymatic treatment also involves one or more of ultrasonic treatment, and treatment with a combination of an endopeptidase and an exopeptidase.

In another embodiment, the methods are used to treat wet or dry blanched peanuts and/or peanut skins. The blanched peanuts and/or peanut skins can be treated with a subtilisin-type protease, such as alcalase or any of the other endopeptidase enzymes described above, optionally with roasting step before or after blanching, but before enzymatic treatment. The blanched peanuts can optionally have the red skin removed before the enzymatic treatment.

In one aspect of this embodiment, the enzymatic treatment also involves one or more of ultrasonic treatment and treatment with a combination of an endopeptidase, such as alcalase, with an exopeptidase, such as flavourzyme or a member of the papain family.

In another embodiment, the methods are used to treat roasted peanuts, roasted red skin peanuts, and/or roasted peanut skins. The roasted peanuts, red skin peanuts, and/or peanut skins can be treated with a subtilisin-type protease, such as alcalase or any of the other endopeptidase enzymes described above, and/or an exopeptidase such as flavourzyme or a member of the papain family, optionally with a wet or dry blanching step before the roasting step, but before enzymatic treatment. The roasted peanuts can optionally have the red skin removed before the enzymatic treatment.

In one aspect of this embodiment, the enzymatic treatment also involves one or more of ultrasonic treatment and treatment with a combination of an endopeptidase, such as a subtilisin type protease, for example, alcalase, with an enzyme having exopeptidase activity, such as flavourzyme or a member of the papain family.

In each of these embodiments, and aspects of these embodiments, the endopeptidase can be alcalase.

In one aspect of those embodiments wherein an exopeptidase is used, the exopeptidase is flavourzyme or a member of the papain family, such as papain.

Each of these specific embodiments can be carried out using any of the endopeptidases specifically described herein.

In each of these embodiments, the enzymatic treatment is carried out for a period of time, and at a temperature and pH, suitable for the particular enzymes being used. Those of skill in the art can readily ascertain suitable conditions using the teachings of the specification and ordinary skill in the art of using these enzymes for other methods, as the listed enzymes are commercially-available and known in the art, albeit for other uses.

In each embodiment, the peanuts, red skin peanuts, and/or peanut skins can optionally be cooled, drained, dried, and the like after the enzymatic treatment, using the conditions described elsewhere herein. The treated peanuts, red skin peanuts, and/or peanut skins can be used to prepare any of a variety of peanut products, including peanut butter, peanut oil, peanut flour, roasted/salted peanuts, and the like. To prepare peanut butter from treated peanuts, the peanuts can be ground using methods known to those of skill in the art. To prepare peanut flour from the treated peanuts, the peanuts are typically partially defatted according to known food processing methods such as for example, a hydraulic press. The partially defatted peanuts can then be ground into flour. Alternately, the treated peanuts can be coarsely ground, treated with an organic solvent to remove fat and then ground finer to prepare a substantially defatted enzymatically treated peanut flour.

Alternately, the treated peanuts can be used to prepare peanut oil. Unlike highly refined peanut oil, this “un-refined” peanut oil, which can be a cold-pressed peanut oil, a solvent-extracted peanut oil, or a combination thereof, is hypoallergenic. Most highly refined peanut oils remove the peanut allergens and have been shown to be safe for the vast majority of peanut-allergic individuals (Crevel, et al, (2000). “Allergenicity of refined vegetable oils”. Food and Chemical Toxicology 38 (4): 385-93). However, cold-pressed peanut oils typically do not remove the allergens, and can be highly dangerous to people with peanut allergy (Hourihane, et al, (1997). “Randomised, double blind, crossover challenge study of allergenicity of peanut oils in subjects allergic to peanuts”. BMJ 314 (7087): 1084-8). The peanut oil obtained using the methods described herein is advantageous, as it offers the advantages of an oil that has not been highly treated, without the disadvantages of high allergen content. The resulting peanut oil can be used in all applications in which peanut oil is used.

### VII. Measuring the Rupture Force of the Treated and Untreated Peanuts

In each of the embodiments described herein, it can be important to avoid over-treating the peanuts, such that they become overly soft. The goal of the treatment is to provide hypoallergenic peanuts, which maintain as close as feasible the physical and mechanical properties of an untreated peanut, while having reduced allergen content.

The physical and mechanical properties of peanuts, including the rupture force of peanut kernels, is described, for example, in Iraj Bagheri et al., Elixir Agriculture 36 (2011) 3552-3557. In one embodiment, the rupture force of peanuts treated using the methods described herein does not decrease the rupture force of the peanuts, in any direction, by more than about 30%, about 20%, about 15%, or about 10%. For example, the rupture force can be determined using a biological material test apparatus. A biological material test device can determine the rupture force of peanut kernels, where the kernels are put under a compression load until the kernel rupture is initiated. A suitable apparatus includes at least three components, including a platform, driving unit, electric circuits for inducing the force applied to the peanut kernels, and a force gauge (for example, a Lutron FG-5020; Lutron). The peanut kernel can be placed on a seat at the bottom of a platform and pressed with a motion probe at a constant speed (such as 25 mm/min). When the kernel begins to rupture, the force required to rupture the kernel can be recorded by a force dynamometer (ideally with a reading accuracy of about 0.0 IN) after switching off the motion mechanism. Ideally, a reasonable sample of kernels is used to ensure reproducibility. The rupture force towards each main direction can be measured carried out for a set number of kernels, such as 20 kernels. There are three orthogonal axes along which the rupture force can be measured, including the plane that contains the suture line, an axis perpendicular to that plane, and the longitudinal axis through the hilum (Braga G C, Couto S M, Hara T, Almeida Neto J T P. Mechanical Behaviour of Macadamia Nut under Compression Loading. J Agric Eng Res. 1999; 72: 239-45).

### EXAMPLES

The following examples are for illustrative purposes only and are not intended to be a detailed catalogue of all the different ways in which the present invention may be implemented or of all the features that may be added to the present invention. One skilled in the art will appreciate that the following Examples are exemplary and that numerous changes, modifications, and alterations can be employed without departing from the scope of the presently disclosed subject matter.

### Example 1

### Treatment of Raw Peanut Kernels with Sonication and a Subtilisin Type Protease

As disclosed herein, raw peanut kernels are sonicated for 1 hour in buffer solution, incubated with different amount of alcalase for various time at pH 7.5, then vacuum dried. The variations of Ara h 1 and Ara h 2 contents in soluble and insoluble portions of peanuts treatments are evaluated by sandwich ELISA and SDS-PAGE, respectively. The in vitro IgE-binding capacity of treated peanut extracts is determined by a competitive inhibition ELISA using pooled plasma of 10 peanut allergic patients. Samples with lower in vitro IgE-binding are used for human skin prick tests (SPTs) in peanut allergic individuals. The maximum reductions of Ara h 1 and Ara h 2 levels are obtained following 3 hour digestion with alcalase at concentrations of at least about 4 U/100 g peanut. Such samples show the lowest in vitro IgE-binding and lead to the lowest allergic response in human SPTs.

Ultrasound-Assisted Alcalase Treatment of Raw Peanuts Kernels

Raw peanut kernels are purchased from Good Earth Peanut Company (Skippers, Va.) and weighed into a set of beakers (20 g per beaker). After adding 40 ml phosphate buffer (pH 7.5), samples are sonicated in a water bath sonicator (Branson Cleaning Equipment Company, Danbury, Conn.) for no more than about 1 hour at 50 Hz.

Alcalase preparation (3.026 units/ml, from Bacillus licheniformis) is purchased from EMD Chemicals, Inc. (San Diego, Calif.). A liquid alcalase preparation is added to the buffer containing sonicated peanuts in an enzyme/peanut ratio of 0 unit/100 g peanuts, 0.76 unit/100 g peanuts, 1.51 unit/100 g peanuts, 3.03 unit/100 g peanuts, 4.54 unit/100 g peanuts or 6.05 unit/100 g peanuts. Samples are incubated for 1, 2, 3, 4 or 5 hours at 37° C., and then drained. Soaking solutions are collected separately for subsequent analysis. Enzyme treated peanuts are dried at 70° C. overnight in a vacuum oven (Fisher Scientific, Pittsburgh, Pa.), which generally removes the excess moisture and inactivates the enzyme. The dried treated peanuts are ground into paste using a high speed blender followed by mortar and pestle, and are then transferred into sterile plastic containers and stored at 4° C. for protein analysis and allergenicity tests. Paste from skinless raw peanut kernels that are neither sonicated nor treated with enzyme are used as control.

Peanut Protein Extraction and Determination

Two grams of peanut paste from each treatment are mixed with 20 ml of phosphate buffer (pH 7.8) and stirred at room temperature for 1 h. The mixtures are then centrifuged at 3000 g for 10 min and the supernatants collected into 50 ml tubes. The precipitates are then extracted one more time following the same procedure. The supernatants from two extractions of the same peanut paste sample are then combined. The volumes of supernatant are recorded for each sample, and used in subsequent calculation of the protein content (or allergen concentration) of the peanuts. The supernatants are then centrifuged again at 3000 g for 10 min and the lipid layers on the top of aqueous supernatants are removed using transfer pipettes; the isolated supernatants are stored at 4° C. The precipitates isolated in the last centrifugation step are extracted (according to the procedure of Schmitt, D. A, Nesbit, J. B., Hurlburt, B. K., Cheng, H., & Maleki, S. J. (2010). “Processing can alter the properties of peanut extract preparations.” Journal of Agricultural and Food Chemistry, 58, 1138-1143) using standard electrophoresis sample treatment buffer containing glycerol, SDS and dithiothreitol to isolate insoluble protein.

Determination of Soluble Protein by BCA Method

Protein concentrations in soaking solutions and supernatants from centrifugation are determined by the Bicinchoninic acid (BCA) method using Pierce BCA Protein Assay Kits (Rockford, Ill.). Samples are diluted 3-5 times with deionized water to bring the protein concentration in test samples down to the linear range of BSA calibration curve (0-2.0 mg/ml). Protein concentration in each of the peanut soaking solution and supernatant extract is measured as mg protein/ml solution while the total soluble protein content of the peanut samples is measured as mg protein per gram peanuts.

SDS-PAGE of Soluble and Insoluble Protein Fractions

Extracts of treated and untreated skinless raw peanuts are diluted with sample treatment buffer (pH 6.8 Tris buffer containing glycerol, SDS and dithiothreitol) to total protein concentration of 1 mg/ml then heated in a boiling water bath for 10 minutes. After cooling to room temperature, samples (20 ul/well) are loaded to 4/12.5% polyacrylamide gel and separated using a Bio-Rad Mini Protein III system (Bio-Rad, Hercules, Calif.). Purified peanut allergens Ara h 1 and Ara h 2 (Indoor Biotechnologies, Charlottesville, Va.) are used as references. The gel is resolved at the power conditions recommended by Bio-Rad (200 V, 120 mA and 45 min), stained with Coomassie brilliant blue R-250 solution overnight. After destaining, the gels are photographed with a Gel Doc XR imaging system (Bio-Rad, Hercules, Calif.).

Determination of Ara h 1, Ara h 2 and Ara h 6 Concentrations using Sandwich ELISA

Concentrations of Ara h 1 and Ara h 2 in soaking solutions and supernatants from centrifugation are determined by sandwich ELISA kits from Indoor Biotechnology (Charlottesville, Va.) as previously described (Li, H., Yu, J Ahmedna, M., & Goktepe, I. (2013). “Reduction of major peanut allergen Ara h 1 and Ara h 2 in roasted peanuts by ultrasound assisted enzymatic treatment.” Food Chemistry, 141, 762-768). Concentration of Ara h6 is determined using sandwich ELISA kits following the published methods.

The concentrations of Ara h 1, Ara h 2 and Ara h 6 in samples (in μg protein per ml solution) are calculated using a standard curves developed from purified Ara h 1, Ara h 2 and Ara h 6 by the same ELISA procedure. The results are expressed as μg of detectable protein per gram peanuts using the following equations:

Ara h 1̂g/g peanut)=Ara h 1̂g/ml)×Volume extract (ml)/peanut weight (g)

Ara h 2̂g/g peanut)=Ara h 2̂g/ml)×Volume extract (ml)/peanut weight (g)

Ara h 6̂g/g peanut)=Ara h 6̂g/ml)×Volume extract (ml)/peanut weight (g)

Determination of IgE Binding of Treated Peanut Extracts with Human Plasma

A competitive inhibition enzyme-linked immunosorbent assay (ciELISA) was used to determine the in vitro IgE-binding of soluble portions in peanut samples as previously described (Chung, S. Y., Yang, W., & Krishnamurthy, K. (2008). “Effects of Pulsed UV-light on peanut allergens in extracts and liquid peanut butter.” Food Chemistry, 73, 400-404). Pooled plasma of 10 patients with known peanut allergy is purchased from Plasma Lab Intemational (Everett, Wash.). The patients are selected according to their clinical history, and then screened by ImmunoCAP test of individual's blood for peanut-specific IgE. The ImmunoCAP of the pooled plasma is used in the study is generally higher than 100 kU/L.

Skin Prick Tests (SPTs) on Allergic Patients

Treated peanut extracts with significantly lower in vitro IgE-binding compared to the extract from roasted peanuts that are not treated with sonication or enzyme are filtered through 0.22 μιτι sterile syringe filters (Millipore, St Louis, Mo.) and are tested on the tryptic soy agar (TSA) culture plates to ensure the absence of microorganisms. Sterile extracts are used for human skin prick test.

Volunteer Recruitment and Inclusion Criteria: Subjects are screened for participation based on self-reports of clinical peanut allergy. All volunteers are interviewed by an allergist, who reviews their clinical history to specifically determine if the subject had a previous IgE-mediated reaction to peanut ingestion, consistent with a positive clinical history for a peanut allergy. Following the interview, subjects undergo skin prick testing using the FDA-approved Standard Peanut Extract (SPE) (Greer Laboratories, Lenoir, N.C.). Those subjects with a positive clinical history and a positive skin test to SPE are selected for Skin Prick Tests (SPTs) to the alcalase-treated extracts.

SPTs are conducted on the peanut-allergic subjects meeting inclusion criteria. Subjects have to avoid antihistamines for 7 days prior to testing. The positive and negative controls (histamine and saline, respectively) and the extracts are applied using a Greer Pick® device to the ventral forearm. The SPT wheal (hive) and flare (redness) are recorded 15 minutes after extract application. The SPT wheal and flare size in millimeters for each condition are outlined with a ballpoint pen, and transferred with permanent tape to the skin test recording form. The mean wheal diameter for each condition is calculated as follows: the largest wheal diameter and the diameter at a 90 degree angle at the midpoint of the largest diameter are summed; this sum is divided by 2. A 3 mm wheal diameter larger than the negative saline control is considered a positive SPT.

Effects of Ultrasonication and Alcalase Treatments on Ara h 1, Ara h2 and Ara h 6 Concentrations

The concentrations of Ara h 1, Ara h 2 and Ara h 6 residues in peanuts are typically determined and used as indicators of treatment efficiency. Samples treated with ultrasonication and alcalase show measurable total soluble protein and are selected for the evaluation of Ara h 1, Ara h 2 and Ara h 6 levels in comparison with soluble protein extracts from raw peanuts not treated with either sonication or enzyme. Treatment of sonicated raw peanuts with alcalase reduces both Ara h 1, Ara h 2 and Ara h 6 over time, typically in an enzyme concentration-dependent manner.

SOS-PAGE of Proteins In Soluble And Insoluble Fractions Of Peanuts SDS-PAGE is used to visualize the effectiveness of ultrasound-alcalase treatment of raw peanuts on the degradation of allergenic proteins Ara h 1, Ara h 2 and Ara h 6, particularly in the insoluble portion of the raw peanut extracts, or ‘pellets’ from the centrifugation described above. None Ara h 1, Ara h 2 and Ara h 6 is present in significant amounts from either extracts or pellets of alcalase treated peanut samples.

Results of In Vitro IgE-Binding Tests

A competitive inhibition ELISA is performed using pooled plasma from 10 patients with clinically confirmed peanut allergy to evaluate the change of in vitro allergenicity of peanut extracts due to enzyme treatment. Only samples with a minimum total soluble protein concentration and a measured Ara h 1 and Ara h 2 degradation efficiency of 99% are selected for this test; the control is peanut extract that was neither sonicated nor treated enzymatically.

Results of Human Skin Prick Tests (SPTs)

Human skin prick tests (SPTs) compare the average wheal size due to application of solutions of ultrasonicated raw peanuts treated with alcalase to SPE (standard peanut extract).

Oral Food Challenges

An oral food challenge (OFC) for patients sensitive to peanuts using ultrasonicated raw peanut kernels treated with alcalase and standard controls is conducted according to standard procedures, such as open OFC and blinded OFC, or a modified OFC procedure in the field, (see for example Nowak-We, A., et al, “Work Group report: Oral food challenge testing.” J Allergy Clin Immunol 2009;123:S365-83; Blumchen, K., et al. “Modified oral food challenge used with sensitization biomarkers provides more real-life clinical thresholds for peanut allergy.” Journal of Allergy and Clinical Immunology (2014) 134 (2), Pages 390-398.e4)

### Example 2

### Treatment of Raw Peanut Kernels with Blanching and a Subtilisin

Raw peanut kernels were blanched in boiling water for about 5 minutes, drained and then cooled to about 50° C. The cooled peanuts were incubated in an alcalase solution (pH 7.5 phosphate buffer, 20 mM) at 50° C. for 0.5-3 hours with varying ratios of enzyme to peanut (1.52-9.09 unit/100 g dry peanuts or 0.036-0.216%, w/w, dry weight) as summarized below. The treated peanuts were dried in at 80° C. for 20 hours in an Isotemp 281 A vacuum oven (Fisher Scientific, Pittsburgh, Pa.). The dried peanuts were cooled to room temperature and packed in plastic containers. A small amount (50 g) of enzyme treated and untreated peanut samples were ground into paste using a high speed blender followed by mortar and pestle for allergen analysis.

To evaluate the effect of (a) enzyme to peanut ratio and (b) enzyme treatment time, a 7×6 two-factor factorial design was employed. Seven levels of enzyme to peanut ratio (0 unit/100 g peanuts, 1.52 unit/100 g peanuts, 3.03 unit/100 g peanuts, 4.54 unit/100 g peanuts, 6.05 unit/100 g peanuts, 7.56 unit 100 g peanuts and 9.09 unit/100 g peanuts, equivalent to 0 ml/100 g peanuts, 0.5 ml/100 g peanuts, 1 ml/100 g peanuts, 1.5 ml/100 g peanuts, 2 ml/100 g peanuts, 2.5 ml/100 g peanuts and 3 ml/100 g peanuts) and six levels of treatment time (0.5, 1.0, 1.5, 2.0, 2.5 and 3.0 hours) were tested. A total 42 experiments were conducted according above procedure. Raw peanuts not blanched or exposed to enzyme were used as control. All experiments were conducted at pH 7.5, and 50° C.

Following enzymatic treatment, the peanut protein in both the supernatants and in the centrifugation solid (or pellet) samples were extracted and analyzed according to the methods disclosed above.

Effects of Alcalase Treatments on Ara h 1, Ara h2 and Ara h 2 Concentrations

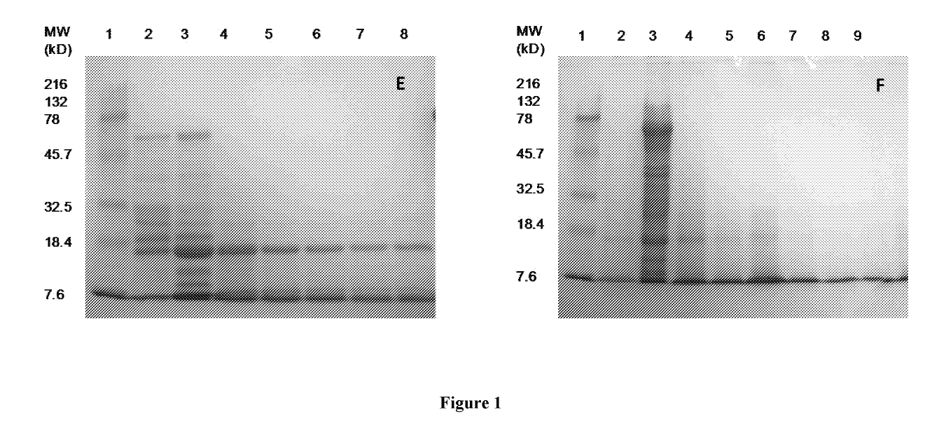

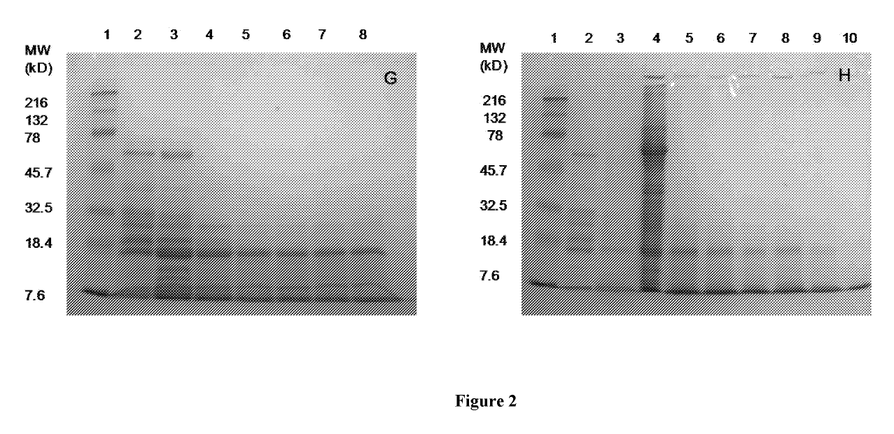

The concentrations of Ara h 1, Ara h 2 and Ara h 6 residues in peanut kernels were determined and used as indicators of treatment efficiency. Results are presented in FIG. 1, FIG. 2 and Table 1. Blanching and soaking raw peanuts in the phosphate buffer increased the extactability of allergens particularly, Ara h 2 and Ara h 6, compared to the control (peanuts without blanching and enzyme treatment). The enzyme (alcalase) to peanut ratio affected the residual allergen levels in the peanuts, while the impact of enzyme treatment time is relatively small. The highest reductions of Ara h 1, Ara h 2 and Ara h 6 concentrations were achieved at an alcalase to peanut ratio of 4.54 U/100 g peanut. A further increase in alcalase concentration did not result in substantially higher reduction in allergen content. Data also showed that at lower enzyme to peanut ratios, increasing treatment time resulted in increased reductions of allergens, especially Ara h 2 and Ara h 6. When the enzyme concentration was above 3.03 U/100 g peanuts, increasing the treatment time from 0.5 hr to 3 hr did not significantly change the residual allergen levels.

The IgE binding of treated peanut extracts is tested with human plasma as described herein and will show significant reduction in IgE binding.

SDS-PAGE results of soluble and insoluble portions of raw peanuts showed that heat treatment, such as blanching, increased the extractability of peanut proteins. It also showed that protein bands with molecular weight between 14 to 18.4 kD were less sensitive to alcalase hydrolysis. Proteins in this range may include Ara h 2 and Ara h 6. The enzyme treatment time did not obviously effect on these protein bands, but a significant reduction in band intensity was observed when the alcalase concentration increased from 1.52 U/100 g peanuts to 6.5 U/100 g peanuts, which is in good agreement with allergen levels determined by sandwich ELISA.

TABLE 1
Effects of alcalase on protein solubility and concentration of extractable
Ara h1, Ara h2 and Ara h6 in blanched raw peanut kernels

| Treat- | | | Ara h1 | | Ara h1 | Ara h2 | | Ara h2 | Ara h6 | | Ara h6 |
|---|---|---|---|---|---|---|---|---|---|---|---|
| ment | E/S (U/g | E/S | (ug/g | | Reduction | (ug/g | | Reduction | (ug/g | | Reduction |
| time | peanuts) | (%, v/w) | peanut) | Std | (%)* | Peanut) | Std | (%)** | Peanut) | Std | (%)*** |
| 0.5 hr | 0 | 0.0 | 6036.98 | 362.48 | 0.00 | 3812.84 | 72.10 | 11.55 | 1173.57 | 16.14 | 11.05 |
| | 1.52 | 0.5 | 49.81 | 2.34 | 99.17 | 499.19 | 17.14 | 88.42 | 328.98 | 3.67 | 75.06 |
| | 3.03 | 1.0 | 50.43 | 2.32 | 99.16 | 109.46 | 3.68 | 97.46 | 45.32 | 0.82 | 96.56 |
| | 4.54 | 1.5 | 13.24 | 1.21 | 99.78 | 4.05 | 0.78 | 99.91 | 6.50 | 0.19 | 99.51 |
| | 6.05 | 2.0 | 4.45 | 0.19 | 99.93 | 4.10 | 0.36 | 99.90 | 3.56 | 0.09 | 99.73 |
| | 7.56 | 2.5 | 6.77 | 1.09 | 99.89 | 0.46 | 0.31 | 99.99 | 1.97 | 0.09 | 99.85 |
| | 9.09 | 3.0 | 9.52 | 1.12 | 99.84 | 0.32 | 0.31 | 99.99 | 1.49 | 0.09 | 99.89 |
| | Control | | 5269.66 | 453.06 | | | | | 351.32 | 9.89 | |
| 1.0 hr | 0 | 0.0 | — | — | — | 4310.69 | 61.55 | 0.00 | 1034.21 | 14.67 | 21.61 |
| | 1.52 | 0.5 | 116.77 | 3.65 | 98.07 | 811.92 | 16.23 | 81.16 | 338.15 | 3.75 | 74.37 |
| | 3.03 | 1.0 | 81.4 | 8.9 | 98.65 | 88.19 | 3.19 | 97.95 | 69.32 | 0.69 | 94.75 |
| | 4.54 | 1.5 | 21.74 | 1.02 | 99.64 | 3.50 | 0.80 | 99.92 | 8.51 | 0.18 | 99.35 |
| | 6.05 | 2.0 | 4.06 | 0.18 | 99.93 | 2.22 | 0.33 | 99.95 | 3.48 | 0.09 | 99.74 |
| | 7.56 | 2.5 | 13.14 | 0.98 | 99.78 | 0.40 | 0.30 | 99.99 | 2.87 | 0.08 | 99.78 |
| | 9.09 | 3.0 | 4.65 | 0.19 | 99.92 | 0.31 | 0.31 | 99.99 | 1.40 | 0.10 | 99.89 |
| | Control | | 5180.69 ± 340.66 | | | | | | 248.96 | 8.15 | |
| 1.5 hr | 0 | 0.0 | 5119.66 | 189.6 | 15.20 | 3139.50 | 63.12 | 27.17 | 810.57 | 17.07 | 38.56 |
| | 1.52 | 0.5 | 256.27 | 21.36 | 95.75 | 914.96 | 19.00 | 78.77 | 517.58 | 3.48 | 60.77 |
| | 3.03 | 1.0 | 15.33 | 15.33 | 99.75 | 80.31 | 11.29 | 98.14 | 83.24 | 0.88 | 93.69 |
| | 4.54 | 1.5 | 29.9 | 2.47 | 99.50 | 5.86 | 0.78 | 99.86 | 11.97 | 0.19 | 99.09 |
| | 6.05 | 2.0 | 7.14 | 0.49 | 99.88 | 0.97 | 0.43 | 99.98 | 4.35 | 0.09 | 99.67 |
| | 7.56 | 2.5 | 7.23 | 0.43 | 99.88 | 0.68 | 0.31 | 99.98 | 5.02 | 0.07 | 99.62 |
| | 9.09 | 3.0 | 5.95 | 0.48 | 99.90 | 0.55 | 0.31 | 99.99 | 3.35 | 0.10 | 99.75 |
| | Control | | | | | | | | 303.42 | 8.12 | |
| 2.0 hr | 0 | 0.0 | 3361.97 | 130.7 | 44.31 | 2236.83 | 48.73 | 48.11 | 822.65 | 106.49 | 37.65 |
| | 1.52 | 0.5 | 627.59 | 57.11 | 89.60 | 57.94 | 9.95 | 98.66 | 240.8 | 64.21 | 81.75 |
| | 3.03 | 1.0 | 57.97 | 4.16 | 99.04 | 55.51 | 5.96 | 98.71 | 77.01 | 36.16 | 94.16 |
| | 4.54 | 1.5 | 8.43 | 0.33 | 99.86 | 3.15 | 1.03 | 99.93 | 7.28 | 2.32 | 99.45 |
| | 6.05 | 2.0 | 5.98 | 0.57 | 99.90 | 6.62 | 0.93 | 99.85 | 6.1 | 2.00 | 99.54 |
| | 7.56 | 2.5 | 3.12 | 0.24 | 99.95 | 17.97 | 1.56 | 99.58 | 2.58 | 0.10 | 99.80 |
| | 9.09 | 3.0 | 4.97 | 0.57 | 99.92 | 6.64 | 1.61 | 99.85 | 1.68 | 0.40 | 99.87 |
| — | control | | 5385.52 | 962.26 | 0.00 | 1296.30 | 195.45 | | — | — | — |
| 2.5 hr | 0 | 0.0 | — | — | — | 1227.16 | 126.80 | 71.53 | 266.14 | 107.18 | 79.83 |
| | 1.52 | 0.5 | 631.45 | 6.98 | 89.54 | 16.85 | 9.41 | 99.61 | 530.25 | 93.7 | 59.81 |
| | 3.03 | 1.0 | 68.8 | 8.63 | 98.86 | 29.77 | 4.64 | 99.31 | 92.51 | 16.35 | 92.99 |
| | 4.54 | 1.5 | 8.35 | 0.68 | 99.86 | 2.39 | 1.08 | 99.94 | 27.78 | 10.9 | 97.89 |
| | 6.05 | 2.0 | 6.69 | 0.88 | 99.89 | 4.29 | 1.04 | 99.90 | 4.26 | 0.81 | 99.68 |
| | 7.56 | 2.5 | 4.65 | 0.54 | 99.92 | 12.95 | 1.16 | 99.70 | 6.69 | 0.89 | 99.49 |
| | 9.09 | 3.0 | 9.03 | 1.75 | 99.85 | 14.73 | 1.11 | 99.66 | 6.86 | 0.19 | 99.48 |
| | Control | | 5296.55 | 642.21 | | 1257.29 | 177.79 | | | | |
| 3.0 hr | 0 | 0.0 | 3211.76 | 30.98 | 46.80 | 871.04 | 54.41 | 79.79 | 1319.34 | 31.54 | 0.00 |
| | 1.52 | 0.5 | 420.59 | 24.25 | 93.03 | 22.37 | 8.98 | 99.48 | 987.77 | 130.01 | 25.13 |
| | 3.03 | 1.0 | 75.4 | 5.68 | 98.75 | 34.42 | 5.75 | 99.20 | 177.25 | 13.91 | 86.57 |
| | 4.54 | 1.5 | 22.2 | 0.81 | 99.63 | 7.04 | 1.19 | 99.84 | 31.31 | 2.03 | 97.63 |
| | 6.05 | 2.0 | 10.33 | 0.49 | 99.83 | 12.88 | 0.93 | 99.70 | 5.17 | 0.46 | 99.61 |
| | 7.56 | 2.5 | 3.89 | 0.22 | 99.94 | 6.62 | 0.97 | 99.85 | 6.33 | 2.26 | 99.52 |
| | 9.09 | 3.0 | 3.16 | 0.5 | 99.95 | 2.45 | 0.94 | 99.94 | 4.12 | 2.02 | 99.69 |
| | Control | | | | | 1280.28 | 194.25 | | | | |

Control: The mean/average of extractable Ara h 1, Ara h 2 and Ara h 6 in untreated peanuts.
*The percentage of Ara h 2 reduction was calculated using 6036.98 ug/g peanut as reference.
**The percentage of Ara h 2 reduction was calculated using 4310.69 ug/g Peanut as reference.
***The percentage of Ara h 6 reduction was calculated using 1319.34 ug/g Peanut as reference.

### Example 3

### Treatment of Raw Peanuts with an Enzyme

A. Raw Peanuts Treated with Alcalase

Raw peanuts were incubated in an alcalase solution (pH 7.5 phosphate buffer, 20 mM) at 50° C. for 0.5-3 hours with varying ratios of enzyme to peanut (2.59-7.77 AU/100 g dry peanuts or −1-3% v/w, dry weight) as summarized below. The treated peanuts were dried at 80° C. for 20 hours in an Isotemp 281 A vacuum oven (Fisher Scientific, Pittsburgh, Pa.). The dried peanuts were cooled to room temperature and packed in plastic containers. A small amount (50 g) of enzyme treated and untreated peanut samples were ground into paste using a high speed blender followed by mortar and pestle for allergen analysis.

To evaluate the effect of (a) enzyme to peanut ratio and (b) enzyme treatment time, a 4×3 two-factor factorial design was employed. Seven levels of enzyme to peanut ratio (0 AU/100 g peanuts, 2.59 AU/100 g peanuts, 5.18 AU/100 g peanuts, and 7.77 AU/100 g peanuts, equivalent to 0 ml/100 g peanuts, 0.5 ml/100 g peanuts, 1 ml/100 g peanuts, 2 ml/100 g peanuts, and 3 ml/100 g peanuts) and six levels of treatment time (1.0, 2.0, and 3.0 hours) were tested. A total 12 experiments were conducted according above procedure. Raw peanuts not exposed to enzyme were used as control. All experiments were conducted at pH 7.5, and 50° C.

Following enzymatic treatment, the peanut protein was extracted and analyzed according to the methods disclosed above. The protein concentration in the soaking solution and the centrifugation supernatants were determined by the BCA method disclosed herein.

Analysis by SDS-PAGE and sandwich ELISA showed that the presence of each of Ara h 1, Ara h 2 and Ara h 6 are reduced in both the soluble and insoluble protein fractions. As disclosed herein, the treatment of unblanched raw peanut with alcalase was conducted at alcalase to peanut ratio of 1-3% (v/w,) which is equivalent to 2.59-7.77 Ason unit per 100 g of peanuts and treatment time 0.5-2.0 hours at 50° C. and pH 7.5 (20 mM phosphate buffer). The controls were peanuts treated with phosphate buffer at same pH and temperature for same period of time without alcalase. The results (Table 2) show that alcalase is very effective at reducing allergenic proteins in raw peanuts. In particular, treatment of raw peanut at 1% (v/w) of alcalase for 0.5 hr at 50° C. reduced Ara hi, Ara h 2 and Ara h 6 levels by 100%., 99.6%. and 65%., respectively. When the dose of alcalase was 2%, the reduction of Ara h 6 increased to 96%. Based on preliminary results, further increase to the alcalase dosage did not result in a more significant reduction of Ara h 6.

The IgE binding of treated peanut extracts is similarly tested with pooled human plasma, as described herein.

TABLE 2
Effects of alcalase on protein solubility and concentration of extractable Ara h1, Ara h2 and Ara h6 in raw peanut kernels

| | | | | | | | | | | | | | |
|---|---|---|---|---|---|---|---|---|---|---|---|---|---|
| Enz % | | | | % | | | % | | | % | | | % |
| (v/w) | E/S | 0.5 hr | Stdev | Reduction | 1.0 hr | Stdev | Reduction | 1.5 hr | Stdev | Reduction | 2.0 hr | Stdev | Reduction |

Ara h 1

| | | | | | | | | | | | | | |
|---|---|---|---|---|---|---|---|---|---|---|---|---|---|
| 0.0 | 0 | 2633.58 | 120.65 | | 3763.72 | 252.47 | | 4224.98 | 107.86 | | 2628.42 | 149.48 | |
| 1.0 | 2.59 | 0.00 | 0.00 | 100.00 | 0.00 | 0.00 | 100.00 | 0.00 | 0.00 | 100.00 | 0.06 | 0.00 | 100.00 |
| 2.0 | 5.19 | 0.02 | 0.04 | 100.00 | 1.12 | 1.29 | 99.97 | 0.00 | 0.00 | 100.00 | 3.65 | 0.21 | 99.86 |
| 3.0 | 7.77 | 1.17 | 1.06 | 99.96 | 0.00 | 0.00 | 100.00 | 0.00 | 0.00 | 100.00 | 0.00 | 0.00 | 100.00 |

Ara h 2

| | | | | | | | | | | | | | |
|---|---|---|---|---|---|---|---|---|---|---|---|---|---|
| 0.0 | 0 | 4367.82 | 198.09 | | 4856.25 | 141.02 | | 6738.73 | 1047.98 | | 2049.23 | 108.48 | |
| 1.0 | 2.59 | 18.09 | 1.20 | 99.59 | 15.79 | 1.54 | 99.67 | 19.03 | 1.89 | 99.55 | 3.09 | 0.51 | 99.85 |
| 2.0 | 5.19 | 5.51 | 1.37 | 99.87 | 6.49 | 1.53 | 99.87 | 1.19 | 0.56 | 99.97 | 1.50 | 0.04 | 99.93 |
| 3.0 | 7.77 | 3.58 | 0.86 | 99.92 | 2.02 | 0.81 | 99.96 | 1.95 | 1.05 | 99.95 | 0.42 | 0.03 | 99.98 |

Ara h 6

| | | | | | | | | | | | | | |
|---|---|---|---|---|---|---|---|---|---|---|---|---|---|
| 0.0 | 0 | 3687.65 | 150.69 | | 3207.12 | 101.99 | | 3076.89 | 163.71 | | 3433.59 | 277.46 | |
| 1.0 | 2.59 | 1288.77 | 170.04 | 65.05 | 1096.66 | 30.04 | 65.81 | 981.66 | 94.38 | 68.10 | 1065.45 | 83.41 | 68.97 |
| 2.0 | 5.19 | 145.09 | 12.35 | 96.07 | 124.10 | 10.12 | 96.13 | 116.97 | 13.33 | 96.20 | 130.96 | 5.28 | 96.19 |
| 3.0 | 7.77 | 108.42 | 7.01 | 97.06 | 83.69 | 9.40 | 97.39 | 102.55 | 14.03 | 96.67 | 109.95 | 11.78 | 96.80 |

*E/S in units of AU enzyme/100 g peanut

B. Raw Peanuts Treated with Papain

Raw peanuts were incubated in a papain solution (pH 7.0 phosphate buffer, 20 mM) at 48° C. for 0.5-2 hours with varying ratios of enzyme to peanut (2,621,550-13,107,750 USP/NF U/100 g dry peanuts or 0.05-0.25%, w/w, dry weight) as summarized below. The treated peanuts were dried at 80° C. for 20 hours in an Isotemp 281 A vacuum oven (Fisher Scientific, Pittsburgh, Pa.). The dried peanuts were cooled to room temperature and packed in plastic containers. A small amount (50 g) of enzyme treated and untreated peanut samples were ground into paste using a high speed blender followed by mortar and pestle for allergen analysis.

To evaluate the effect of (a) enzyme to peanut ratio and (b) enzyme treatment time, a 6×4 two-factor factorial design was employed. Six levels of enzyme to peanut ratio (0 USP/NF U/100 g peanuts, 2,621,550 USP/NF U/100 g peanuts, 5,243,100 USP/NF U/100 g peanuts, 7,864,650 USP/NF U/100 g peanuts, 10,486,200 USP/NF U/100 g peanuts, and 13,107,750 USP/NF U/100 g peanuts, equivalent to 0 mg/100 g peanuts, 50 mg/100 g peanuts, 100 mg/100 g peanuts, 150 mg/100 g peanuts, 200 mg/100 g peanuts, and 250 mg/100 g peanuts) and four levels of treatment time (0.5, 1.0, 1.5 and 2.0 hours) were tested. A total 24 experiments were conducted according to above procedure. Raw peanuts not exposed to enzyme were used as control. All experiments were conducted at pH 7.0, and 48° C.

Following enzymatic treatment, the peanut protein was extracted and analyzed according to the methods disclosed above. The protein concentration in the soaking solution and the centrifugation supernatants was determined by the BCA method disclosed herein.

Analysis by SDS-PAGE and sandwich ELISA showed that the presence of each of Ara h 1, Ara h 2 and Ara h 6 are reduced in both the soluble and insoluble protein fractions. The effectiveness of papain on the reduction of raw peanut allergens was studied at papain dose of 0.1-0.5% (w/w, dry powder from Acrose Chemical Company) which is equivalent to 15,729,300-26,215,500 USP unit per 100 g of peanut, and treatment time 0.5-2.0 hour at 48° C. and pH 7.0 (20 mM, phosphate buffer). Papain can be used in a temperature range of about 35° C. to about 60° C., and at a pH of between about 4 and about 9. The controls were peanuts treated with phosphate buffer at same pH and temperature for same period of time without papain. The results show that an effective papain dose to achieve reduction of Ara h 1, Ara h 2 and Ara h 6 is between about 0.3% and about 0.5%. In this enzymatic treatment range, the reductions measured for Ara h 1, Ara h 2 and Ara h 6 were in the ranges of 99.2%-99.8% (Ara h 1), 97.2%-99.3%

(Ara h 2) and 66.6%-84.2% (Ara h 6) depending on papain dose. Similar to alcalase, treatment time longer than 0.5 hr did not show significant improvement on the reduction of these allergens.

The IgE binding of treated peanut extracts is similarly tested with human plasma, as described herein.

C. Raw Peanuts Treated with Neutrase

Raw peanuts were incubated in a neutrase solution (pH 6.5 phosphate buffer, 20 mM) at 50° C. for 0.5-2 hours with varying ratios of enzyme to peanut (0.24-1.92 AU/100 g dry peanuts or 0.2-1.6%, v/w, dry weight) as summarized below. The treated peanuts were dried at 75° C. for 16 hours in an Isotemp 281 A vacuum oven (Fisher Scientific, Pittsburgh, Pa.). The dried peanuts were cooled to room temperature and packed in plastic containers. A small amount (20 g) of enzyme treated and untreated peanut samples were ground into paste using a high speed blender followed by mortar and pestle for allergen analysis.

To evaluate the effect of (a) enzyme to peanut ratio and (b) enzyme treatment time, a 6×4 two-factor factorial design was employed. Six levels of enzyme to peanut ratio (0 unit/100 g peanuts, 0.24 unit/100 g peanuts, 0.48 unit/100 g peanuts, 0.96 unit/100 g peanuts, 1.44 unit/100 g peanuts, and 1.92 unit/100 g peanuts, equivalent to 0 ml/100 g peanuts, 0.1 ml/100 g peanuts, 0.2 ml/100 g peanuts, 0.4 ml/100 g peanuts, 0.8 ml/100 g peanuts, 1.2 ml/100 g peanuts and 1.6 ml/100 g peanuts) and four levels of treatment time (0.5, 1.0, 1.5 and 2.0 hours) are tested. A total 24 experiments were conducted according to above procedure. Raw peanuts not exposed to enzyme were used as control. All experiments were conducted at pH 6.5, and 50° C.

Following enzymatic treatment, the peanut protein was extracted and analyzed according to the methods disclosed above. The protein concentrations in the soaking solution and the centrifugation supernatants were determined by the BCA method disclosed herein.

Analysis by SDS-PAGE and sandwich ELISA showed that the presence of each of Ara h 1, Ara h 2 and Ara h 6 are reduced in both the soluble and insoluble protein fractions. The treatment of unblanched raw peanuts with neutrase (liquid product of Novozyme)was conducted at neutrase to peanut ratio of 0.2%-1.6% (v/w) which is equivalent to 0.24-1.96 Anson Unit per 100 g raw peanuts and treatment time of 0.5-2.0 hours at 50° C. and pH 6.5 (10 mM phosphate buffer). Neutrase can be used in a temperature range of about 45° C. to about 55° C., and at a pH of between about 5.5 and about 7.5. The controls were peanuts treated with phosphate buffer at same pH and temperature for same period of time without neutrase. The reductions measured for Ara hi, Ara h 2 and Ara h 6 were in the ranges of 98.6%-99.4% (Ara hi), 97.0%-99.3% (Ara h2) and 24.2%-69.1% (Ara h6) depending on enzyme dose. The maximum Ara h6 reduction of 69% was achieved at neutrase dose of 1.6% and treatment time 1.0 hours and yielded reduction of 99.3% of each of Ara hi and Ara h2.

The IgE binding of treated peanut extracts is similarly tested with pooled human plasma, as described herein.

### Example 4

### Treatment of Raw Peanuts with Enzyme Combinations

A. Raw Peanuts Treated with Alcalase+Flavourzyme

Raw peanuts were incubated in an alcalase solution (pH 7.5 phosphate buffer, 20 mM) at 50° C. using a subtilisin concentration of 5.19 AU/100 g peanuts (2%, v/w).

After the subtilisin treatment, the peanuts were heated at 80° C. for 10 minutes and then the pH adjusted to 4.5 with HCl and NaOH, then incubated with 250 LAPU/100 g peanuts of Flavourzyme for 1 hour at 40° C.

After treatment, the peanuts were dried at 75° C. for 16 hours in an Isotemp 281 A vacuum oven (Fisher Scientific, Pittsburgh, Pa.). The dried peanuts were cooled to room temperature and packed in plastic containers. A small amount (20 g) of enzyme treated and untreated peanut samples were ground into paste using a high speed blender followed by mortar and pestle for allergen analysis.

Following enzymatic treatment, the peanut protein was extracted and analyzed according to the methods disclosed above. The protein concentration in the soaking solution and the centrifugation supernatants was determined by the BCA method disclosed herein.

Preliminary results showed that the presence of Ara h2 was significantly reduced (68% reduction), but the presence of Ara h 1 and Ara h 6 were not as reduced (<20%).

B. Raw Peanuts Treated with Alcalase+Papain

Raw peanuts were incubated in an alcalase solution (pH 7.5 phosphate buffer, 10 mM) at 50° C. for 1 hour using a subtilisin concentration 5.19 AU/100 g peanuts (2%, v/w).

After the subtilisin treatment, the peanuts in the buffer solution were heated at 80° C. for 10 minutes, the pH was then adjusted to 6.5 with HCl solution, then incubated with 10,486,200 USP/NF U/100 g (0.2%, w/w, dry weight) of papain for 1 hour at 50° C.

After treatment, the peanuts were dried at 75° C. for 16 hours in an Isotemp 281 A vacuum oven (Fisher Scientific, Pittsburgh, Pa.). The dried peanuts were cooled to room temperature and packed in plastic containers. A small amount (20 g) of enzyme treated and untreated peanut samples were ground into paste using a high speed blender followed by mortar and pestle for allergen analysis.

Following enzymatic treatment, the peanut protein was extracted and analyzed according to the methods disclosed above. The protein concentration in the soaking solution and the centrifugation supernatants was determined by the BCA method disclosed herein.

Preliminary results showed that Ara h 1 was substantially reduced (94.9%), but the presence of each of Ara h 2 and Ara h 6 were not as reduced (<20%).

C. Raw Peanuts Treated with Papain+Akalase

Raw peanuts were incubated in a papain solution (pH 7.0 phosphate buffer, 10 mM) at papain concentration of 10,486,200 USP/NF U/100 g peanuts at 50° C. for 1 hour.

After papain treatment, the peanuts in the buffer solution were heated at 80° C. for 10 minutes to inactivate papain, the pH was adjusted to 7.5 with NaOH solution, then incubated with 5.18U/100 g (2%, v/w, dry weight) of alcalase for 1 hour at 50° C.

After treatment, the peanuts were dried at 80° C. for 20 hours in an Isotemp 281 A vacuum oven (Fisher Scientific, Pittsburgh, Pa.). The dried peanuts were cooled to room temperature and packed in plastic containers. A small amount (20 g) of enzyme treated and untreated peanut samples were ground into paste using a high speed blender followed by mortar and pestle for allergen analysis.

Following enzymatic treatment, the peanut protein was extracted and analyzed according to the methods disclosed above. The protein concentration in the soaking solution and the centrifugation supernatants was determined by the BCA method disclosed herein.

Preliminary results showed that the presence of each of Ara h 1 and Ara h 2 was greatly reduced (>99.8% for each), but the presence of Ara h 6 was less significantly reduced (24.9%).

The IgE binding of treated peanut extracts is similarly tested with human plasma, as described herein.

D. Raw Peanuts Treated with Neutrase and Flavourzyme

Raw peanuts were incubated in a 0.8%, v/w Neutrase solution (pH 7 phosphate buffer, 10 mM) at 45° C. for 1 hour.

After the Neutrase treatment, the peanuts in the buffer solution were heated at 80° C. for 10 minutes to inactivate papain, the pH was adjusted to 4.5 with HCl solution, then incubated with 250 LAPU/100 g (0.5%, w/w, dry weight) of Flavourzyme for 1 hour at 40° C.

After treatment, the peanuts were dried at 80° C. for 16 hours in an Isotemp 281 A vacuum oven (Fisher Scientific, Pittsburgh, Pa.). The dried peanuts were cooled to room temperature and packed in plastic containers. A small amount (20 g) of enzyme treated and untreated peanut samples were ground into paste using a high speed blender followed by mortar and pestle for allergen analysis. Raw peanuts not exposed to enzyme were used as control.

Following enzymatic treatment, the peanut protein was extracted and analyzed according to the methods disclosed above. The protein concentration in the soaking solution and the centrifugation supernatants was determined by the BCA method disclosed herein.

Preliminary results showed that the presence of each of Ara h 1 (3.7%), Ara h 2 (70.3%) and Ara h 6 (25.4%) was not substantially reduced.

E. Raw Peanuts Treated with Papain and Flavourzyme

Raw peanuts were incubated in a papain solution (pH 7.0, phosphate buffer, 20 mM) at papain to peanut ratio of 10,486,200 USP/NF U/100 g (0.2%, w/w, dry weight), 48° C. for 1 hour.

After the papain treatment, the peanuts in the buffer solution were heated at 80° C. for 10 minutes to inactivate papain, pH was adjusted to 4.5 with HCl solution, then incubated with 250 LAPU/100 g (0.5%, w/w, dry weight) of Flavourzyme for 1 hour at 40° C.

After treatment, the peanuts were dried at 80° C. for 16 hours in an Isotemp 281 A vacuum oven (Fisher Scientific, Pittsburgh, Pa.). The dried peanuts were cooled to room temperature and packed in plastic containers. A small amount (20 g) of enzyme treated and untreated peanut samples were ground into paste using a high speed blender followed by mortar and pestle for allergen analysis.

Following enzymatic treatment, the peanut protein was extracted and analyzed according to the methods disclosed above. The protein concentrations in the soaking solution and the centrifugation supernatants were determined by the BCA method disclosed herein.

Preliminary results showed that the presence of each of Ara h 1 (91.1%) and Ara h 2 (44.6%) was reduced, but Ara h 6 (8.3%) not substantively affected.

Incorporation by Reference

The patents and publications listed herein describe the general skill in the art. All publications, patents, and patent applications mentioned in this specification are herein incorporated by reference to the same extent as if each individual publication, patent, or patent application was specifically and individually indicated to be incorporated by reference. In the case of any conflict between a cited reference and this specification, the specification shall control.

In describing embodiments of the present application, specific terminology is employed for the sake of clarity. However, the presently disclosed subject matter is not intended to be limited to the specific terminology so selected. Nothing in this specification should be considered as limiting the scope of the presently disclosed subject matter. All examples presented are representative and non-limiting. The above-described embodiments can be modified or varied, without departing from the presently disclosed subject matter, as appreciated by those skilled in the art in light of the above teachings. It is therefore to be understood that, within the scope of the claims and their equivalents, the presently disclosed subject matter can be practiced otherwise than as specifically described.

The claims below are representative in nature of at least some aspects of the subject matter disclosed in this provisional patent application. The claims are not meant to limit the scope of the subject matter disclosed herein and are provided for representative purposes only.

1-28. (canceled)

29. A method for reducing the allergenic protein content of raw peanuts or red skin peanuts comprising contacting the raw peanuts or red skin peanuts with a hypoallergenically-effective amount of at least one subtilisin-type enzyme and/or at least one exopeptidase.

30. The method of claim 29, wherein the subtilisin-type enzyme is alcalase.

31. The method of claim 29, wherein the raw peanuts or red skin peanuts are contacted with a hypoallergenically-effective amount of at least one subtilisin-type enzyme and at least one exopeptidase.

32. The method of claim 31, wherein the exopeptidase is papain or flavourzyme.

33. The method of claim 31, wherein the method reduces the allergenic protein content of raw peanuts.

34. The method of claim 29, further comprising subjecting the raw peanuts or red skin peanuts to wet or dry blanching, before or after the raw peanuts or red skin peanuts are contacted with the at least one subtilisin-type enzyme and/or at least one exopeptidase.

35. The method of claim 31, further comprising subjecting the raw peanuts or red skin peanuts to wet or dry blanching, before or after the raw peanuts or red skin peanuts are contacted with the at least one subtilisin-type enzyme and at least one exopeptidase.

36. The method of claim 35, wherein the method reduces the allergenic protein content of raw peanuts.

37. The method of claim 29, further comprising subjecting the raw peanuts or red skin peanuts to an ultrasonic treatment, at any stage before the treatment with the subtilisin-type enzyme and/or exopeptidase.

38. The method of claim 31, further comprising subjecting the raw peanuts or red skin peanuts to an ultrasonic treatment, at any stage before the treatment with the subtilisin-type enzyme and exopeptidase.

39. The method of claim 38, wherein the method reduces the allergenic protein content of raw peanuts.

40. The method of claim 31, wherein the allergenicity is reduced by greater than about 50%.

41. The method of claim 40, wherein reducing the allergenic protein content refers to the reduction of any combination of two of Ara h 1, Ara h 2, or Ara h 6.

42. The method of claim 40, wherein reducing the allergenic protein content refers to the reduction of each of Ara h 1, Ara h 2, and Ara h 6.

43. The method of claim 40, wherein reducing the allergenic protein content refers to the reduction of each of Ara h 1 and Ara h 2 by greater than 95% and the reduction of Ara h 6 by greater than 60%.

44. A method for reducing the allergenic protein content of raw peanuts comprising
a. subjecting the raw peanuts to wet blanching or an ultrasonic treatment,
b. contacting the raw peanuts with a hypoallergenically-effective amount of at least one exopeptidase,
c. contacting the raw peanuts with a hypoallergenically-effective amount of at least one subtilisin-type enzyme.

45. The method of claim 44 wherein said exopeptidase is papain and said subtilisin-type enzyme is alcalase.

46. A peanut-containing food product wherein the allergenicity of the peanuts in the peanut-containing food product has been reduced by greater than about 50% relative to untreated peanuts by the method according to claim 44.

47. The peanut-containing food product of claim 44 wherein the allergenicity reduction refers to the reduction of each of Ara h 1, Ara h 2, and Ara h 6.

48. The peanut-containing food product of claim 45, wherein reducing the allergenic protein content refers to the reduction of each of Ara h 1 and Ara h 2 by greater than 95% and the reduction of Ara h 6 by greater than 60%.
